(19) United States
(12) Patent Application Publication
(10) Pub. No.: US 2011/0298817 A1
(43) Pub. Date: Dec. 8, 2011

(54) PORTABLE TERMINAL WITH PEEKING PREVENTION FUNCTION

(75) Inventor: Haruyoshi Oshinome, Osaka (JP)

(73) Assignee: KYOCERA CORPORATION, Kyoto-shi, Kyoto (JP)

(21) Appl. No.: 12/994,726

(22) PCT Filed: May 26, 2009
(86) PCT No.: PCT/JP2009/002324

§ 371 Date: Feb. 25, 2011

(30) Foreign Application Priority Data
May 27, 2008 (JP) 2008-138080

(51) Int. Cl. G09G 5/02; G09G 5/00

(52) U.S. Cl. 345/589; 345/581

(57) ABSTRACT

A mobile terminal having a peeping prevention function by which only a portion not desired to be peeped is made difficult to see so that the display screen is easy to see and the privacy is protected. The mobile terminal, when displaying information on the display, searches information to be displayed for a piece of information, extracts a predetermined piece of information, changes the display attribute of the extracted piece of information to a display attribute for decreasing visibility, and displays the information with the changed display attribute on the display.

### TECHNICAL FIELD

The present invention relates to a control of display on a display screen of, for example, a mobile terminal, and in particular to a technology for improving the viewability of the display screen while the peeping prevention function is running.

### BACKGROUND ART

In recent years, mobile terminals such as mobile phones have been provided with various communication functions such as a function to make a call by voice, and display various information on the display. For example, e-mails and pages of the Internet can be displayed.

Mobile terminals are convenient in that they can be used everywhere due to their mobility. On the other hand, when they are used in a train or the like, the displayed contents on the display may be seen by other people.

There will be no problem when the displayed contents are, like advertisements, contents that are generally open to the public, but a problem may occur when the displayed contents are, like e-mails directed to a person or telephone numbers of personal mobile phones, contents that concern privacy matters.

In view of this, technologies for changing the viewing angle of the display depending on the position of the own device, for example, a technology for narrowing the viewing angle in the train station, have been developed (Patent Literature 1).

Also, a technology has been developed in which the whole text of an e-mail is hidden except for an area specified by the user while an e-mail is created or browsed (Patent Literature 2). In more detail, according to the technology, only the area specified by the user is displayed normally and the other areas of the text are hidden. More specifically, when an e-mail is being created, a portion including Japanese kana characters which are being input and are yet to be converted into Chinese characters is displayed normally. Also, when e-mails are being browsed, several characters which change as any direction key is pressed are displayed normally. The other portions and characters in these cases are displayed in a color close to the background color.

According to these technologies, the content such as an e-mail text displayed on the display is prevented from being recognized easily by other people.

### CITATION LIST

### Patent Literature

[Patent Literature 1] Japanese Patent Application Publication No. 2007-33935
[Patent Literature 2] Japanese Patent Application Publication No. 2004-252773

### SUMMARY OF INVENTION

### Technical Problem

However, according to the former technology, the display as a whole is made difficult to see so that the displayed content cannot be recognized easily. Thus a problem of the technology is that it is difficult for the user him/herself to see the display.

In the latter technology, a portion of the e-mail display screen is seen as easily as normal, but the other portions are difficult to see for the user him/herself. However, if the portion, which is difficult to see, is enlarged, the function to prevent the peeping is disabled. This is a problem of this technology.

It is therefore an object of the present invention to provide a mobile terminal having a peeping prevention function by which only a portion not desired to be peeped is made difficult to see so that the display screen is easy to see and the privacy is protected.

### Solution to Problem

In order for the above problem to be solved, the present invention provides a display device, comprising: a display; a display control unit operable to display information on the display; an attribute setting unit operable to set a display attribute of information to be displayed on the display; and an extraction unit operable to extract a piece of information, wherein the display control unit causes the extraction unit to extract a predetermined piece of information from the information to be displayed on the display, and causes the attribute setting unit to change a display attribute of the extracted piece of information to a display attribute for decreasing visibility.

Note that the information mentioned above refers to characters such as Japanese kana characters, Chinese characters, alphabets, and numerals, and also refers to signs, figures, pictograms, images and so on. Furthermore, both two-byte and one-byte characters can be processed by the present invention.

Also, the display attribute includes color, size, and font type in the case of character, and color and size in the case of sign, figure or the like. The display attribute further includes hatching and blinking.

Also, “decrease the visibility” refers to controlling the visibility so that the object is visible but the content cannot be recognized easily.

### Advantageous Effects of Invention

In the mobile terminal of the present invention with the above-described structure, only a predetermined piece of information is made difficult to see and the other information are displayed normally. Thus the present invention provides the same usability as per normal and protects the privacy of the user as well.

Furthermore, the whole information is displayed on the display screen except for a predetermined piece of information. Thus the display screen is easy to see as a whole. This provides the user with more usability than the case where a conventional peeping prevention function is running.

### BRIEF DESCRIPTION OF DRAWINGS

FIG. 1 is a functional block diagram showing the structure of the mobile phone of the present invention.

FIG. 2 illustrates screens that are displaying received e-mails.

FIG. 3 illustrates screens on which an e-mail is being created.

FIG. 4 shows examples of the structure and contents of an extraction condition table 2110.

FIG. 5A shows an example of the structure and contents of an application condition table 2310, FIG. 5B shows an example of the structure and contents of a time condition table 2320, and FIG. 5C shows an example of the structure and contents of a position condition table 2330.

FIG. 6 shows examples of the structure and contents of an extraction condition table 2210.

FIG. 7 shows an example of the structure and contents of display data (1610, 1620) stored in the display control unit 1600.

FIG. 8 is a flowchart showing the e-mail display process.

FIG. 9 is a flowchart showing the e-mail display process with the peeping prevention function running.

FIG. 10 is a flowchart showing the e-mail creation process.

FIG. 11 is a flowchart showing the e-mail creation process with the peeping prevention function running.

### DESCRIPTION OF EMBODIMENTS

### Embodiment

<Outline>

The peeping prevention function loaded in the mobile terminal of the present invention selects and hides only information that is actually needs to be hidden, in view of the fact that users do not desire to hide uniformly all the information displayed on the display device. It should be noted here that the hiding means that characters or the like are displayed in the state where they are difficult to see.

That is to say, when information is displayed on the display, only a minimum portion is hidden, so that the user can understand the information as a whole, but the essential point is hardly recognized by the other people. For example, when a received e-mail is displayed, a company name among the text of the e-mail is made difficult to see.

As described above, the hiding means that information such as characters is displayed in the state where it is difficult to see. There are various display forms in which the information is difficult to see. For example, the information may be displayed in a color close to the background color, or may be displayed in small letters, or may be displayed on the background with both reduced in brightness. In the present embodiment, the information is displayed in a color close to the background color.

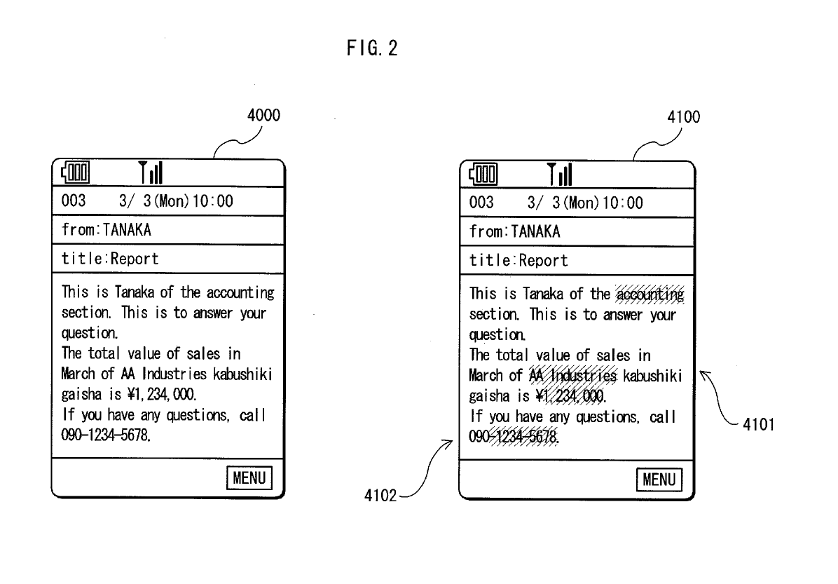

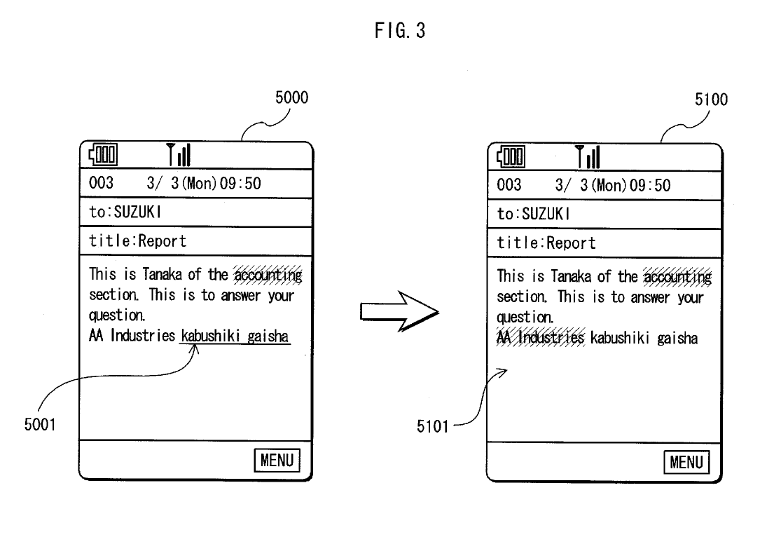

Here the peeping prevention function of the mobile terminal of the present invention will be explained briefly with reference to FIGS. 2 and 3.

FIG. 2 illustrates screens that are displaying received e-mails.

The screen 4000 represents a screen displaying an e-mail without running the peeping prevention function, and the screen 4100 represents a screen displaying an e-mail while running the peeping prevention function. In FIG. 2, the shaded areas indicate characters or character sequences that are hidden. Hereinafter, a “character sequence” means one or more characters.

In the screen 4100, “accounting”, “AA Industries”, “1,234,000”, and “090-1234-5678” among the e-mail text are hidden.

Next, FIG. 3 illustrates screens on which an e-mail is being created.

The screen 5000 represents a screen on which actually Japanese kana characters representing “Company Limited” 5001 are currently input. The screen 5100 represents a screen on which Chinese characters representing “Company Limited” converted from the Japanese kana characters are displayed.

In the screen 5000, “AA Industries” has not been hidden yet, but in the screen 5100, “AA Industries” 5101 is hidden.

The following describes the mobile phone with the peeping prevention function of the present invention.

Note that, although the case where the peeping prevention function is run during display and creation of an e-mail is explained in the present embodiment, the present invention is not limited to this case, but may be applied to cases where information is displayed on the display by other applications.

<Structure>

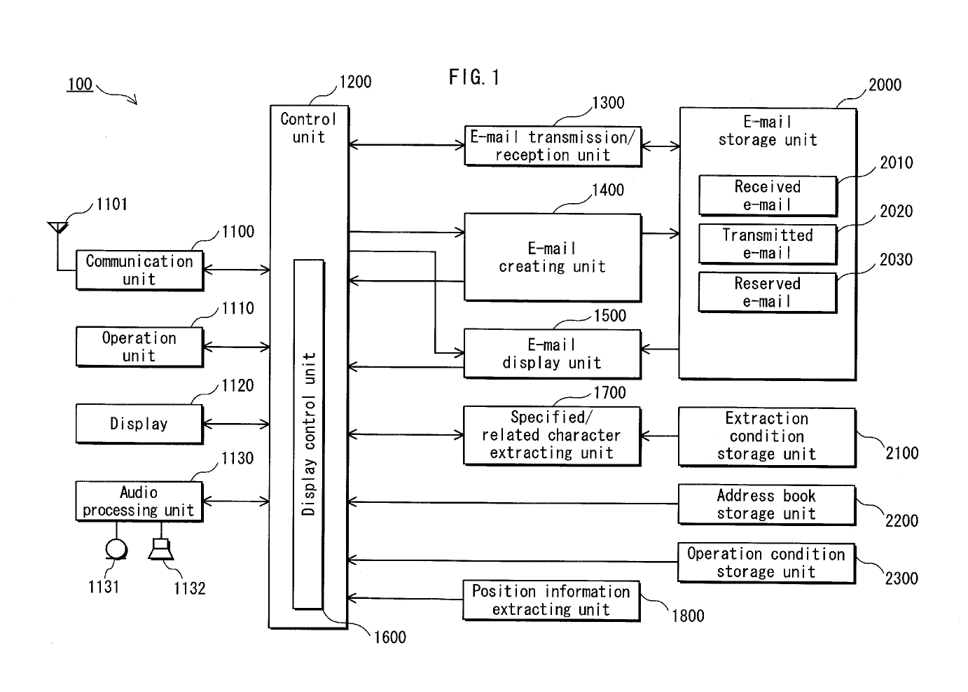

First, the structure of the mobile phone in the embodiment of the present invention will be explained with reference to FIG. 1. FIG. 1 is a functional block diagram showing the structure of the mobile phone.

The mobile phone 100 includes a communication unit 1100, an operation unit 1110, a display 1120, an audio processing unit 1130, a control unit 1200, an e-mail transmission/reception unit 1300, an e-mail creating unit 1400, an e-mail display unit 1500, a specified/related character extracting unit 1700, a position information extracting unit 1800, an e-mail storage unit 2000, an extraction condition storage unit 2100, an address book storage unit 2200, and an operation condition storage unit 2300, wherein the communication unit 1100 is provided with an antenna 1101, the audio processing unit 1130 is provided with a microphone 1131 for inputting external audio and a speaker 1132 for outputting audio signals, and the control unit 1200 includes a display control unit 1600.

The control unit 1200 is provided with a CPU, a memory and the like that are not illustrated, and controls general processes of a mobile phone such as conversation and notification of reception of a call or e-mail. The control unit 1200 also controls processes unique to the present invention by issuing instructions to functional units explained in the following, such as a process of displaying a partial character sequence of a character sequence in a different color from the rest thereof.

Next, the display control unit 1600 included in the control unit 1200 has a function to request the display 1120 to display a character sequence, and store in an internal memory the data of character sequences of one screen to be displayed on the display. The data of character sequences to be displayed will be explained in item <Data> below.

Also, the display control unit 1600 has a function to perform a judgment on whether to run the peeping prevention function, and when it judges that the function should be run, execute the process of the peeping prevention function.

The communication unit 1100 includes a modulation/demodulation circuit, a signal processing circuit and the like, and has a function to communicate with a base station (not illustrated) in accordance with an instruction by the control unit 1200.

The operation unit 1110 includes keys, buttons and the like, and has a function to detect and notify the control unit 1200 of a user operation such as a depression of a button.

The display 1120 includes a display panel such as a liquid crystal display panel, and has a function to display thereon a menu or a text of e-mail in accordance with an instruction by the control unit 1200.

The audio processing unit 1130 has a function to perform processes such as the digitization and modulation/demodulation of audio.

The e-mail transmission/reception unit 1300 has a function to transmit/receive e-mails via the control unit 1200 and the communication unit 1100. The e-mail transmission/reception unit 1300 stores the received e-mails in the e-mail storage unit 2000, and reads e-mails from the e-mail storage unit 2000 and send the e-mails.

The e-mail storage unit 2000 has a function to store the e-mails which include a received e-mail 2010, transmitted e-mail 2020, and a reserved e-mail 2030 which is a not-transmitted e-mail.

The e-mail creating unit 1400 has a function to create a normal e-mail. When the created e-mail is to be displayed on the display 1120, the e-mail creating unit 1400 request it to the display control unit 1600. The created e-mail is stored in the e-mail storage unit 2000.

The e-mail creating unit 1400 has a function to receive, via the control unit 1200, kana characters input by the user and then detected by the operation unit 1110, and perform a kana-kanji conversion (conversion from Japanese kana characters to Chinese characters).

The e-mail display unit 1500 has a function to display the received e-mail 2010, the transmitted e-mail 2020, and the reserved e-mail 2030 on the display 1120. In so doing, the e-mail display unit 1500 passes one display screen of e-mail text to the display control unit 1600, and request it to display the text on the display 1120.

The e-mail display unit 1500 also has a function to perform what is called scrolling. That is to say, when the e-mail text is too long to be displayed in one screen of the display 1120, the e-mail display unit 1500 receives, via the control unit 1200, information of cursor move detected by the operation unit 1110, and changes the e-mail text displayed on the display 1120.

The specified/related character extracting unit 1700 has a function to search the character sequences for a specified character sequence and a related character sequence, and extract the searched character sequences. Note that the specified character sequence is a character sequence that is used as a key to find character sequences to be hidden, and the related characters are character sequences that are to be actually hidden and are related to the specified character sequences.

For example, when a character sequence “1000 man yen” (“man” is a unit representing “ten thousand”), which indicates an amount of money, is to be hidden, the character sequence “yen” is a specified character sequence indicating the money, and “1000 man” placed before “yen” is a related character sequence representing an amount of money.

The position information extracting unit 1800 has a function to measure the position of the device given by the latitude and longitude by using, for example, GPS (Global Positioning System), and notifies the display control unit 1600 of the measured position upon request.

The extraction condition storage unit 2100 has a function to store conditions for the specified/related character extracting unit 1700 to extract specified character sequences and related character sequences. The conditions stored therein will be explained in <Data> below.

The address book storage unit 2200 has a function to store what is called address book.

The operation condition storage unit 2300 has a function to store conditions for running the peeping prevention function. The conditions stored therein will be explained in <Data> below.

Note that a part or all of the structural elements such as the control unit 1200 are realized as the CPU executes corresponding programs.

<Data>

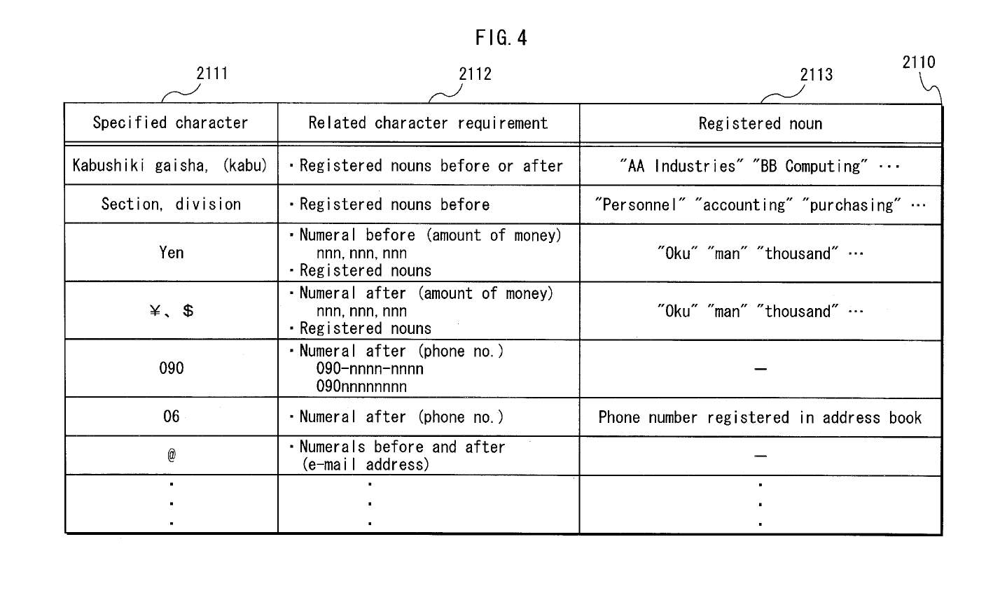

The following explains the data that is mainly used by the mobile phone of the present invention with reference to FIGS. 4-7.

FIG. 4 shows examples of the structure and contents of an extraction condition table 2110.

The extraction condition table 2110 is stored in the extraction condition storage unit 2100, and defines the conditions under which character sequences to be hidden should be extracted from the character sequences to be displayed. This table is referenced by the specified/related character extracting unit 1700.

Note that the extraction condition table 2110 needs to have been created when the peeping prevention function is run, and it is assumed that the user can set and change the contents thereof in view of the degree of secret.

The extraction condition table 2110 is composed of a specified character 2111, a related character requirement 2112, and a registered noun 2113.

The specified character 2111 includes character sequences that are used as the keys for searching for the character sequences to be hidden. In this example, “kabushiki gaisha”, “(kabu)”, “Company Limited”, “Co., Ltd”, “Corporation”, “Corp”, “Incorporated”, “Inc”, and the like are registered as the specified characters for searching for company names when company names are intended to be hidden, and “yen”, “¥” (a symbol representing “yen”), “$” and the like are registered as the specified characters for searching for amounts of money when amounts of money are intended to be hidden

The related character requirement 2112 includes requirements for character sequences to be recognized as related character sequences. The related characters are character sequences that are actually hidden and are related to the specified character sequences.

The registered noun 2113 includes character sequences that are to be hidden, among the character sequences that satisfy the requirements included in the related character requirement 2112.

For example, with regard to “kabushiki gaisha” registered in the specified character 2111, a corresponding requirement registered in the related character requirement 2112 is “registered nouns before or after”, and corresponding nouns registered in the registered noun 2113 are “AA Industries”, “BB Computing” and the like. Accordingly, character sequences such as “AA Industries” and “BB Computing”, among the character sequences placed before and after “kabushiki gaisha”, are hidden as the related characters.

Also, for example, with regard to “yen” registered in the specified character 2111, corresponding requirements registered in the related character requirement 2112 are “registered nouns before (amount of money)” and “registered nouns”, and corresponding nouns registered in the registered noun 2113 are “oku (”oku” is a unit representing “hundred million”)”, “man” and the like. Accordingly, a numeral placed before “yen” in a format representing an amount of money and a character sequence such as “yen” and “man” are hidden as the related character sequences. For example, when “1000 man yen” is displayed, “1000 man” is hidden as the related character sequences.

Furthermore, for example, in Japan, with regard to “090” registered in the specified character 2111, a corresponding requirement registered in the related character requirement 2112 is “numerals after (telephone number)”. Accordingly, numerals placed after “090” in a format representing a telephone number are hidden as the related character sequences.

Furthermore, for example, in Japan, with regard to “06” registered in the specified character 2111, a corresponding requirement registered in the related character requirement 2112 is “numerals after (telephone number)”. Accordingly, numerals placed after “06” in a format representing a telephone number are hidden as the related character sequences.

Even in countries other than Japan, when a number is registered in the specified character 2111 as a character sequence that is recognized as indicating a telephone number, the numerals representing the telephone number is hidden as the related character sequences.

The following is a brief explanation of a procedure for extracting related character sequences.

The procedure includes searching extraction-target character sequences, such as character sequences to be displayed, for a character sequence registered in the specified character 2111, and when the registered character sequence is detected, related character sequences that satisfy requirements registered in the related character requirement 2112 in association with the detected character sequence are searched for.

This will be explained taking a specific example case where related character sequences are extracted from the e-mail text displayed on the screen 4000 shown in FIG. 2.

When a character sequence registered in the specified character 2111 is searched for from the start of the e-mail text, “section” is extracted. Thus related character sequences that satisfy requirements registered in the related character requirement 2112 in association with “section” are extracted.

With regard to the specified character sequence “section”, a corresponding requirement registered in the related character requirement 2112 is “registered nouns before”, thus it is checked whether any of the nouns “personnel”, “accounting”, and “purchasing” and the like in the registered noun 2113 is placed before “section”.

In the e-mail text on the screen 4000, “accounting” is placed before “section”, thus “accounting” is extracted as the related character sequence.

Similarly, by searching the e-mail text until the end of it, specified character sequences and related character sequences are extracted.

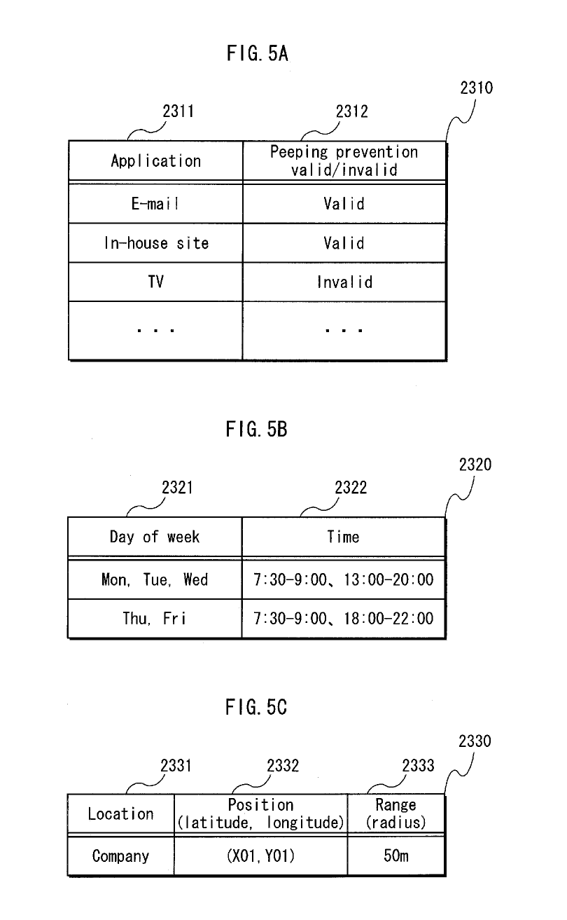

Next, FIG. 5A shows an example of the structure and contents of an application condition table 2310, FIG. 5B shows an example of the structure and contents of a time condition table 2320, and FIG. 5C shows an example of the structure and contents of a position condition table 2330.

The application condition table 2310, time condition table 2320, and position condition table 2330 are tables stored in the operation condition storage unit 2300, and define conditions for running the peeping prevention function. In the present embodiment, it is assumed that the peeping prevention function is run when the three conditions are set and the function is set ON by the user. These tables are referenced by the display control unit 1600.

Note that the condition tables (2310, 2320, and 2330) need to have been created when the peeping prevention function is run, and it is assumed that the user can set and change the contents thereof by selecting the corresponding items on the menu. Also, regardless of these conditions, the peeping prevention function may be run in accordance with a user's instruction, for example, when the user presses a predetermined button while an e-mail is displayed on the display.

The application condition table 2310 is composed of an application 2311 and a peeping prevention valid/invalid 2312.

The application condition table 2310 defines applications on which the peeping prevention function is run. The application 2311 shows applications that can run in the own device (the device containing the application condition table 2310). The peeping prevention valid/invalid 2312 shows whether or not the peeping prevention function is run on the applications shown in the application 2311. When it indicates “valid”, the peeping prevention function is run when a corresponding application is executed, and when it indicates “invalid”, the peeping prevention function is not run when a corresponding application is executed.

For example, when the peeping prevention valid/invalid 2312 indicates “valid” in correspondence with “e-mail” shown in the application 2311, the peeping prevention function is run when the e-mail function is run with the conditions defined in the time condition table 2320 being satisfied.

The time condition table 2320 is composed of a day of the week 2321 and a time 2322.

The time condition table 2320 defines temporal conditions for running the peeping prevention function. The day of the week 2321 and the time 2322 show the day of the week and the time band in which the peeping prevention function is run, respectively.

For example, when the day of the week 2321 specifies “Mon, Tue, Wed”, and the time 2322 specifies “7:30-9:00, 13:00-20:00”, the peeping prevention function is run whenever an e-mail is displayed or created in any of the time periods from half past seven to nine and from hour 13 to hour 20 of Monday, Tuesday, and Wednesday.

The position condition table 2330 is composed of a location 2331, a position 2332, and a range 2333.

The position condition table 2330 defines positional conditions for running the peeping prevention function. In this example, it is assumed that the position condition table 2330 specifies the location where the peeping prevention function is not run.

The location 2331 indicates an identification name of a location. The position 2332 indicates degrees of latitude and longitude of a position at which the peeping prevention function is not run. The range 2333 indicates a radius specifying a range in which the peeping prevention function is not run.

For example, when the location 2331 specifies “company”, the position 2332 specifies “(X01,Y01)”, the range 2333 specifies “50 m”, and the own device (the device including the position condition table 2330) is located in a 50 m radius around a coordinate point (X01,Y01), the peeping prevention function is automatically prevented from being run even if an e-mail is displayed or created.

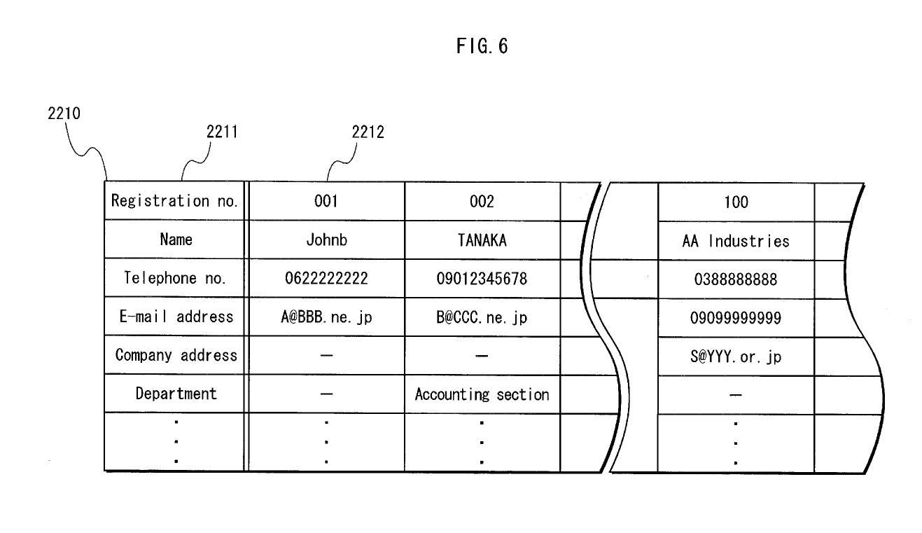

FIG. 6 shows examples of the structure and contents of an extraction condition table 2210.

The address book 2210 is stored in the address book storage unit 2200, and is referenced by the display control unit 1600 when it determines the related character sequences.

The address book 2210 is composed of an item 2211 and a plurality of pieces of personal information 2212.

The item 2211 indicates items regarding the personal information registered in the address book, and includes “registration number”, “name”, “telephone number”, “e-mail address”, “company address”, and “department”. The pieces of personal information 2212 indicate information regarding communication partners including information of the items indicated in the item 2211.

The “registration number” in the item 2211 indicates identifiers of the pieces of personal information 2212 included in the address book. In the present embodiment, the registration number is represented as “001”, “002” or the like.

The “name” indicates the names of the communication partners registered in the address book. The “telephone number” indicates telephone numbers of mobile phones owned by the communication partners registered in the address book. The “e-mail address” indicates e-mail addresses of the communication partners.

For example, a piece of personal information 2212 identified by registration number “001” has a name “JohnB”, telephone number “0622222222”, and an e-mail address “A@BBB.ne.jp”.

For example, when the extraction condition table 2110 shown in FIG. 4 is referenced, the e-mail text is displayed in the state where “0622222222” is hidden.

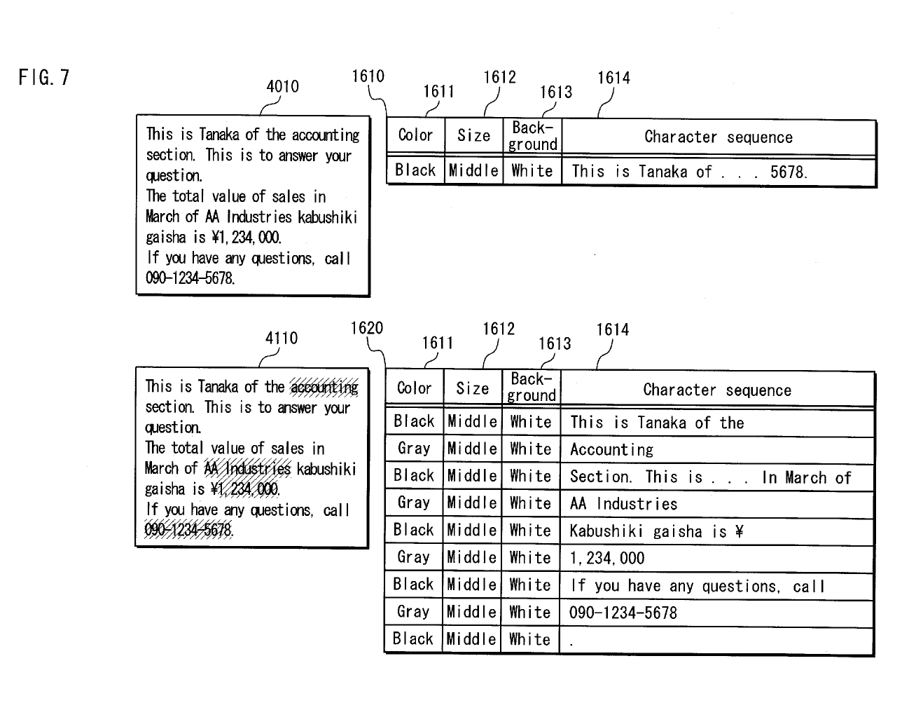

FIG. 7 shows an example of the structure and contents of display data (1610, 1620) stored in the display control unit 1600.

The display data 1610 indicates the display data of a display screen 4010. The display data 1620 indicates the display data of a display screen 4110.

The display data 1610 is composed of a color 1611, a size 1612, a background 1613, and a character sequence 1614. The display data 1620 has a similar structure to the display data 1610.

The color 1611 indicates a display color of the character sequence. The size 1612 indicates the size of one character. The background 1613 indicates the background color of the character. The character sequence 1614 indicates a character sequence to be displayed.

The display screen 4010 shows an e-mail text displayed on the screen without running the peeping prevention function. As shown in the display data 1610, the character sequence 1614 “This is Tanaka of . . . 5678.” is displayed on a “white” background as indicated by the background 1613, with a “medium” size as indicated by the size 1612, and in “black” as indicated by the color 1611.

Also, the display screen 4110 shows an e-mail text displayed on the screen with the peeping prevention function running. As shown in the display data 1620, the character sequence 1614 “This is Tanaka of is displayed on a “white” background as indicated by the background 1613, with a “medium” size as indicated by the size 1612, and in “black” as indicated by the color 1611; and the character sequence 1614 “accounting” is displayed on a “white” background as indicated by the background 1613, with a “medium” size as indicated by the size 1612, and in “gray” as indicated by the color 1611.

Here, the related character sequences, such as “accounting”, are displayed in “gray” which is close to the color of the background (white) so that they are difficult to see compared with the character sequences displayed in black.

<Operation>

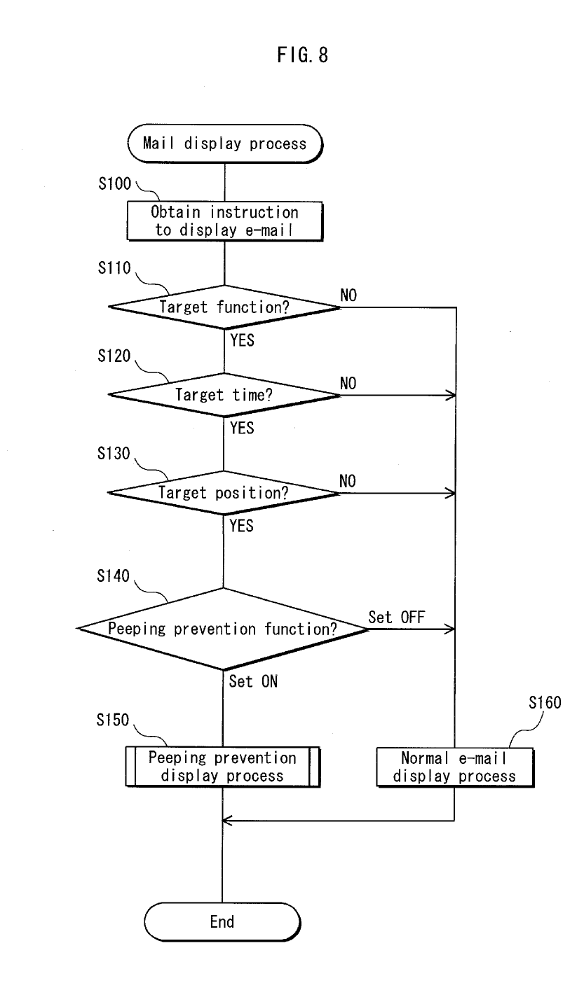

The following explains the operation of the above-described mobile phone with reference to FIGS. 8-11.

In the present embodiment, two operations of the peeping prevention function are explained. That is to say, the operation of displaying an e-mail, and the operation of creating an e-mail.

<Process of Displaying E-Mail>

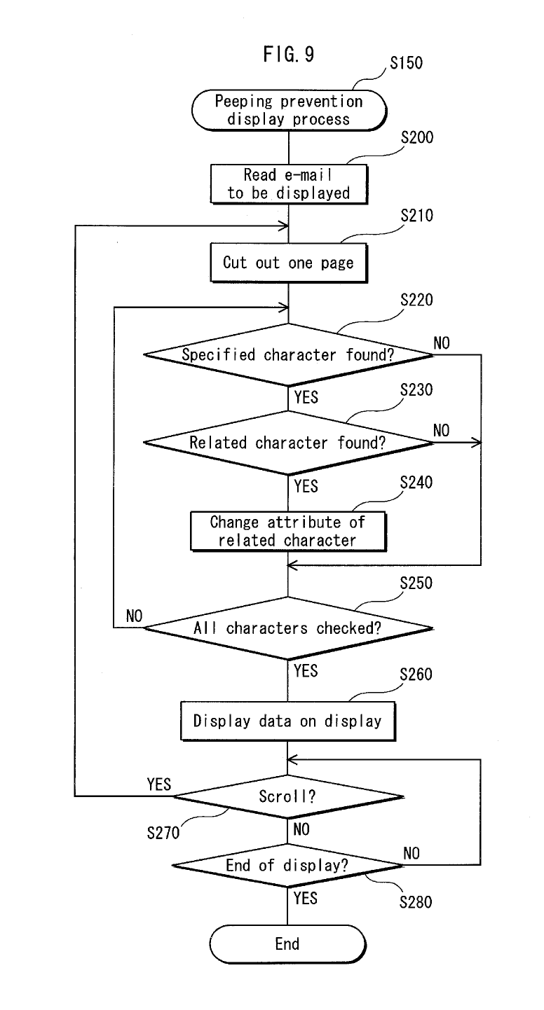

First, the process of displaying an e-mail will be described with reference to FIGS. 8 and 9.

FIG. 8 is a flowchart showing the e-mail display process.

The user performs an operation of specifying an e-mail for display. For example, the user selects an e-mail to be displayed from among a list of e-mails and presses a button which instructs to display the e-mail.

Upon detecting that the operation was performed, the operation unit 1110 notifies the control unit 1200 of the detected operation. Upon receiving the notification, the control unit 1200 judges whether or not the notified operation is an instruction to display an e-mail.

Upon judging that the notified operation is an instruction to display an e-mail, the control unit 1200 requests the e-mail display unit 1500 to display the specified e-mail (step S100). When requesting this, the control unit 1200 passes information for identifying the specified e-mail to the e-mail display unit 1500.

The e-mail display unit 1500 notifies the control unit 1200 that it displays the e-mail, and the display control unit 1600 of the control unit 1200 judges whether or not the peeping prevention function should be run when the e-mail is displayed.

The display control unit 1600 references the application condition table 2310 of the operation condition storage unit 2300, and judges whether the peeping prevention valid/invalid 2312 is “valid” or “invalid” (step S110).

When it judges that the peeping prevention valid/invalid 2312 is valid (step S110:YES), the display control unit 1600 references the time condition table 2320 and judges whether or not the current day of the week and time match the day of the week 2321 and the time 2322 (step S120). Note that the current day of the week and time are obtained from a timer (not illustrated) of the device including the peeping prevention valid/invalid 2312. For example, when the current time is eight o'clock on Monday, it judges that they match.

When it judges that the current day of the week and time matches the day of the week 2321 and the time 2322 (step S120:YES), the display control unit 1600 references the position condition table 2330 and judges whether or not the current position is out of the range 2333 based on the position 2332 (step S130). Note that the current position is obtained from the position information extracting unit 1800.

When it judges that the current position is not within the range 2333 (step S130:YES), the display control unit 1600 judges whether or not the user has set ON the peeping prevention function (step S140). It is assumed here that the judgment on whether or not the user has set ON the peeping prevention function is made by asking the control unit 1200, which stores the corresponding settings made by the user.

When it judges that the user has set ON the peeping prevention function (step S140:Set ON), the display control unit 1600 determines to run the peeping prevention function.

The display control unit 1600 determines not to run the peeping prevention function when it judges that the peeping prevention valid/invalid 2312 is “invalid” (step S110:NO), or when it judges that the current day of the week and time do not match the day of the week 2321 and the time 2322 (step S120:NO), or when it judges that the current position is within the range 2333 (step S130:NO), or when it judges that the user has not set ON the peeping prevention function (step S140:Set OFF).

After determining whether or not to run the peeping prevention function, the display control unit 1600 notifies the e-mail display unit 1500 that the determination has been made and it is ready to obtain display data.

When it is determined to run the peeping prevention function, the peeping prevention function is run and the e-mail display process is performed (step S150); and when it is determined not to run the peeping prevention function, the normal e-mail display process is performed (step S160).

Next, the e-mail display process performed by running the peeping prevention function will be described with reference to FIG. 9. This process corresponds to step S150 shown in FIG. 8.

FIG. 9 is a flowchart showing the e-mail display process with the peeping prevention function running.

Upon receiving from the display control unit 1600 the notification that it is ready to obtain the display data, the e-mail display unit 1500 reads from the e-mail storage unit 2000 the e-mail to be displayed (step S200), cut out one page therefrom, and passes the page to the display control unit 1600 (step S210).

Upon receiving the character sequence data of the e-mail to be displayed, the display control unit 1600 searches the received character sequences for characters registered in the specified character 2111 by referencing the extraction condition table 2110 of the extraction condition storage unit 2100 (step S220).

When it detects a specified character (step S220:YES), the display control unit 1600 extracts a related character by referencing information in the related character requirement 2112 and the registered noun 2113 that correspond to the detected specified character registered in the specified character 2111 (step S230), and continues to search the received character sequence data till the last for specified characters (step S220:NO).

When a related character is detected (step S230:YES), the display control unit 1600 creates the display data 1620 by changing the attribute of the related character (step S240, see FIG. 7). In the present embodiment, it is assumed that the color of the character sequence to be hidden is preliminarily determined in accordance with the color of the background. For example, when background color is white, the color of the character sequence to be hidden should be gray. The way the color of the character sequence is determined is not limited to this, but, for example, the color of the character sequence to be hidden may be set to be a color that is obtained by adding a predetermined value to the brightness value of the background color.

When a related character is not detected (step S230:NO), the display control unit 1600 searches the received character sequence data till the last for the next specified character (step S250:NO, step S220).

When the search of the received character sequence data ends (step S250:YES), the display control unit 1600 passes the display data 1620 to the display 1120 and requests it to display the data.

Upon being requested to display, the display 1120 displays the display data 1620 (step S270, see screen 4100 shown in FIG. 2).

When it detects an operation that instructs to change the display screen like scrolling, the operation unit 1110 notifies the control unit 1200 of it, and the control unit 1200 notifies the e-mail display unit 1500 of it (step S270:YES).

The e-mail display unit 1500 cuts out character sequence data to be displayed from the e-mail text depending on the content of the operation, passes the cut-out character sequence data to the display control unit 1600, and repeats the process from step S210 to step S260.

When it detects an operation instructing to end the e-mail display process, the operation unit 1110 notifies the control unit 1200 of it, and the control unit 1200 notifies the e-mail display unit 1500 of it (step S280), and the e-mail display unit 1500 performs the end process.

<Display Process When E-Mail is Created>

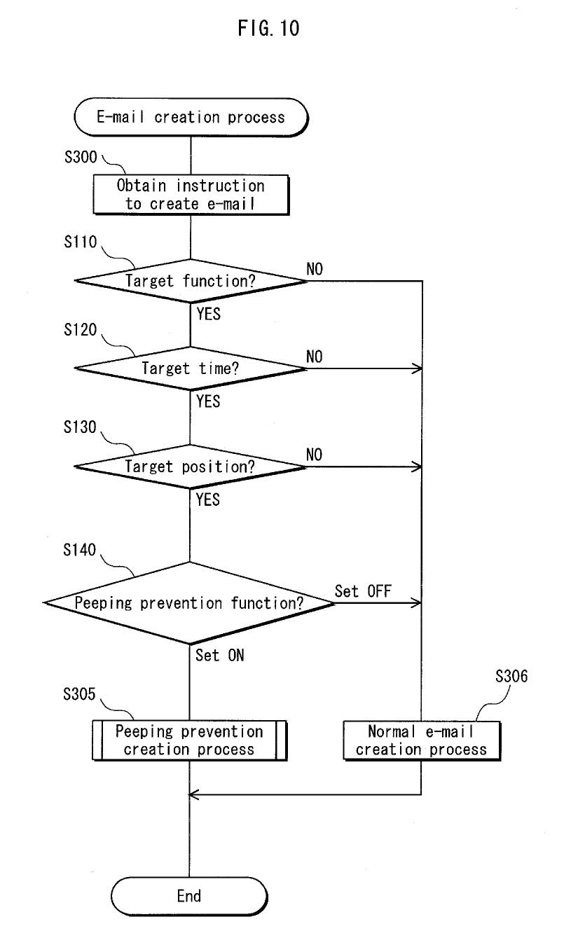

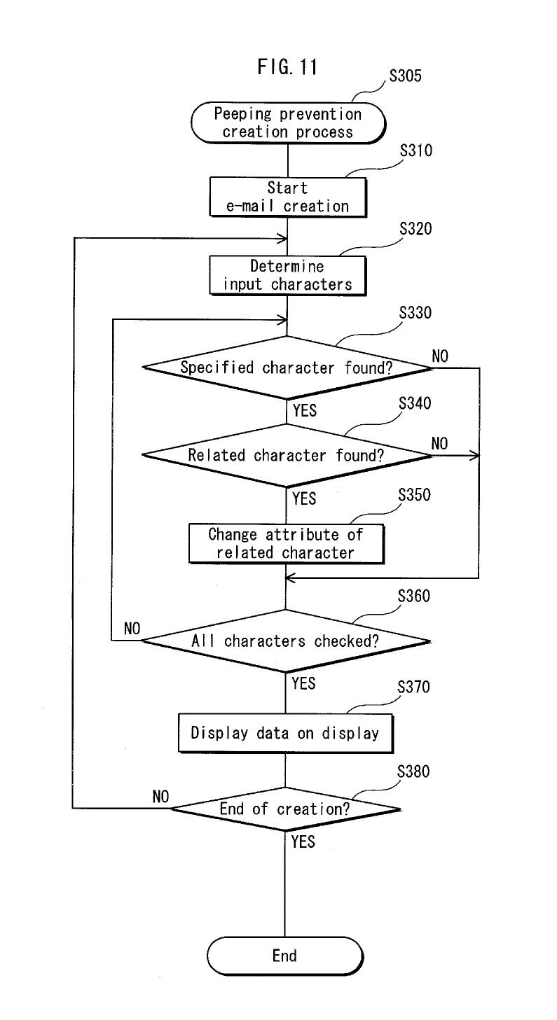

Next, the display process when an e-mail is created will be described with reference to FIGS. 10 and 11.

FIG. 10 is a flowchart showing the e-mail creation process.

This process is almost the same as the e-mail display process having been explained with reference to FIG. 8, and thus difference therefrom will be explained mainly.

The user performs an operation to instruct to create an e-mail, for example, presses the e-mail creation button.

Upon detecting the operation, the operation unit 1110 notifies the control unit 1200 of the detected operation. Upon receiving the notification, the control unit 1200 judges that the notified operation is an instruction to create an e-mail, and requests the e-mail creating unit 1400 to create an e-mail (step S300).

The e-mail creating unit 1400 notifies the display control unit 1600 that it is to create an e-mail. Upon receiving the notification, the display control unit 1600, when an e-mail is to be created, judges whether or not to run the peeping prevention function.

This judgment is the same as that performed in steps S110 through S140 shown in FIG. 8. That is to say, by referencing the application condition table 2310, time condition table 2320, and position condition table 2330 in the operation condition storage unit 2300, the display control unit 1600 judges whether or not the user has set ON the peeping prevention function, and determines whether or not to run the peeping prevention function.

After determining whether or not to run the peeping prevention function, the display control unit 1600 notifies the e-mail creating unit 1400 that the determination has been made and it is ready to create an e-mail.

When it is determined to run the peeping prevention function, the peeping prevention function is run and the e-mail creation process is performed (step S305); and when it is determined not to run the peeping prevention function, the normal e-mail creation process is performed (step S306).

Next, the e-mail creation process performed by running the peeping prevention function will be described with reference to FIG. 11. This process corresponds to step S305 shown in FIG. 10.

FIG. 11 is a flowchart showing the e-mail creation process with the peeping prevention function running.

Upon receiving the notification from the display control unit 1600 that it is ready to create an e-mail, the e-mail creating unit 1400 performs a kana-kanji conversion onto Japanese kana characters input by the user (see the screen 5100 shown in FIG. 3) to determine Chinese characters via the control unit 1200 and the operation unit 1110, and passes the determined character sequence data to the display control unit 1600 (step S320).

Upon receiving the determined character sequence data, the display control unit 1600 stores the received character sequence data into the work memory, and searches the character sequence data in the work memory for a specified character registered in the specified character 2111 by referencing the extraction condition table 2110 in the extraction condition storage unit 2100 (step S330). In this searching, the e-mail stored in the work memory is searched. It should be noted here that the work memory is a memory for storing the character sequence data received from the e-mail creating unit 1400, and it is assumed in the present embodiment that all the created e-mails are stored.

When it detects a specified character (step S330:YES), the display control unit 1600 searches for a related character by referencing information in the related character requirement 2112 and the registered noun 2113 that corresponds to the detected specified character registered in the specified character 2111 (step S340), and when a specified character is not detected (step S330:NO), continues to search the character sequence data in the work memory till the last.

When a related character is detected (step S340:YES), the display control unit 1600 creates the display data 1620 by changing the attribute of the related character (step S350, see FIG. 7).

The display data 1620 is stored as data that is merely to be displayed, separately from the created e-mails that are stored in the work memory. Accordingly, when, by the kana-kanji conversion, a Japanese character sequence is replaced with a Chinese character sequence that is registered as a specified character, the attribute of the corresponding related character in the display data 1620 is changed. For example, in the example shown in FIG. 3, when a Japanese character sequence input after “AA Industries” is replaced with “kabushiki gaisha” that is registered as a specified character, “AA Industries” is detected as a related character, and the attribute thereof is changed.

When a related character is not detected (step S340:NO), the display control unit 1600 searches the character sequence data in the work memory till the last for the next specified character (step S360:NO, step S330).

When the search of the character sequence data in the work memory ends (step S360:YES), the display control unit 1600 passes the display data 1620 to the display 1120 and request the display 1120 to display the data.

Upon being requested to display, the display 1120 displays the display data 1620 (step S370, see screen S100 shown in FIG. 3).

When it detects an operation instructing to end the e-mail creation process (step S380:YES), the operation unit 1110 notifies the control unit 1200 of it, and the control unit 1200 notifies the e-mail creating unit 1400 of it. The e-mail creating unit 1400 stores the e-mail stored in the work memory into the e-mail storage unit 2000, and ends the process.

Until it receives an operation instructing to end the e-mail creation process (step S380:NO), the e-mail creating unit 1400 performs a kana-kanji conversion to convert Japanese kana characters input by the user (see the screen 5100 shown in FIG. 3) into Chinese characters via the control unit 1200 and the operation unit 1110, passes the character sequence data, which is the finally confirmed one, to the display control unit 1600, and repeats the process from step S320 to step S370.

<Supplementary Notes>

Up to now, the mobile phone of the present invention has been explained based on the embodiment. However, the present invention is not limited to the above embodiment, and the mobile phone can be partially modified as follows, for example.

(1) In the embodiment, the peeping prevention function is determined to be run depending on the type of the application. For example, the peeping prevention function is run when an e-mail function is performed. However, the present invention is not limited to this.

For example, when a browsing function for displaying a site on the Internet is run, the peeping prevention function may be run when the following sites are browsed: in-house sites; and security-protected sites such as Internet banking sites.

Also, whether or not to run the peeping prevention function may be determined based on whether the target site is an official site of the mobile phone company or an unofficial site.

Also, the embodiment describes the cases where the peeping prevention function is run in the e-mail display process and the e-mail creation process. However, not limited to this, the target of running the peeping prevention function may be the process of e-mails that are transferred between the own device and predetermined communication partners.

In that case, for example, it may be set that the peeping prevention function is run in the communications with partners who are selected from among partners registered in the address book, or that the peeping prevention function is not run when direct e-mails are displayed.

Also, in the embodiment, only the text of the e-mail is prevented from being peeped. However, the title, sender's name, recipient's name, and so on may be prevented from being peeped as well.

(2) In the embodiment, the day of the week and time are used as the conditions for running the peeping prevention function. However, not limited to this, other temporal conditions may be used.

For example, by referencing the appointment book, it may be judged whether the user is on the road, in the customer's place or the like.

Furthermore, the deadline may be set depending on the application that runs the peeping prevention function. For example, the peeping prevention function may be prevented from being run when 24 hours have passed from the time an e-mail was received or transmitted. Also, the peeping prevention function may be prevented from being run when one week has passed from an update.

(3) In the embodiment, whether or not the user is in the office is used as a condition for running the peeping prevention function. However, other locational conditions may be used.

For example, the peeping prevention function may be prevented from being run when the mobile phone is in a crowd of people, for example, when the mobile phone is in a crowd of people in the train or street, or when the mobile phone is moving.

It is possible to judge whether the mobile phone is in the crowd by analyzing the surrounding sound or images shot by a camera. Also, use of an acceleration sensor or the like makes it possible to judge whether or not the own device is moving.

(4) In the embodiment, GPS is used to detect the position of the own device. However, another method may be used to detect the position.

For example, in the case of the mobile phone, the position may be detected from the base station with which the mobile phone is currently communicating. Also, in the case of the mobile terminal, the position may be detected from the access point of the wireless LAN.

(5) In the embodiment, characters are made to be difficult to see by displaying them with a color that is close to the background color. However, not limited to this, the contrast between the characters and the background may be reduced, or the brightness values of the characters and the background may be made close to each other, or a font that is difficult to read may be used, or the size of the characters may be reduced. The present invention is applicable in so far as the related characters are difficult to recognize for the people except for the user.

Also, in the embodiment, the display attribute of the related characters is changed. However, the display attribute of the specified characters may be changed as well.

(6) In the embodiment, character sequences satisfying the requirements stored in the related character requirement 2112 are stored in the registered noun 2113. However, dictionaries may be provided separately for these purposes as well.

Also, in the embodiment, characters representing amounts of money and departments are used as specified characters. However, other characters may be used as well.

For example, the specified characters may include character “%” representing the ratio, “month, day, hour, second” representing the date and time, “day of the week, Monday, Tuesday, Wednesday”.

Furthermore, in the embodiment, the target of the peeping prevention function is characters. However, not limited to this, the target may be predetermined images. In that case, for example, a character sequence specified as the “alt” attribute in the IMG tag of the HTML (Hyper Text Markup Language) may be used to judge whether or not the image is to be prevented from being peeped. For example, when a character sequence specified to have the “alt” attribute includes a predetermined keyword, the image specified by the IMG tag is judged to be an image that should be prevented from being peeped.

(7) In the embodiment, a mobile phone is explained as one example of the mobile terminal that is provided with the peeping prevention function. However, not limited to a mobile one, for example, a desk-top personal computer or a device for displaying characters or the like may be provided with the peeping prevention function.

This is because, in the office, for example, there are cases where information like personnel evaluation information is displayed on a screen of a personal computer, although such information is not desired to be peeped.

(8) In the embodiment, whether or not to run the peeping prevention function is judged before an e-mail is displayed and the e-mail display process is performed in accordance with the result of the judgment. However, the peeping prevention function may be run in the middle of the normal display process. Also, conversely, the normal display process may be performed in the middle of an e-mail display process in which the peeping prevention function is run.

Such switching between display processes may be performed triggered by a pressing of a predetermined button, or shaking of the mobile phone at a speed higher than a predetermined speed.

Also, while the peeping prevention function is being run, a character sequence which is not being hidden may be specified to be hidden, or a character sequence which is being hidden may be specified to be displayed normally.

For example, a character sequence which is being hidden may be specified with use of a cursor, and then a predetermined key may be pressed so that the display form of the character sequence is changed. Also, when a hidden character sequence is specified, the specified character sequence may be displayed to pop up in a normal display form.

(9) A program for causing the CPU to execute the control processes (see FIG. 8) to achieve the functions of the mobile phone shown in the embodiment may be recorded on a recording medium and distributed via the recording medium. Also, the program may be distributed via any of various communication paths and the like. Such recording mediums include the IC card, optical disc, flexible disc, ROM, and flash memory. The distributed program may be stored for use in memory of a device that is readable by the CPU, and each function shown in the embodiment is achieved as the program is executed by the CPU.

### INDUSTRIAL APPLICABILITY

The present invention provides a technology that is useful when the user watches characters or the like displayed on a display in an environment where the display may be seen by other people.

### REFERENCE SIGNS LIST

100 mobile phone

1100 communication unit

1110 operation unit

1120 display

1130 audio processing unit

1200 control unit

1300 e-mail transmission/reception unit

1400 e-mail creating unit

1500 e-mail display unit

1600 display control unit

1700 specified/related character extracting unit

1800 position information extracting unit

2000 e-mail storage unit

2100 extraction condition storage unit

2200 address book storage unit

2300 operation condition storage unit

1. A display device, comprising:
a display;
a display control unit operable to display information on the display;
an attribute setting unit operable to set a display attribute of information to be displayed on the display; and
an extraction unit operable to extract a piece of information, wherein the display control unit causes the extraction unit to extract a predetermined piece of information from the information to be displayed on the display, and causes the attribute setting unit to change a display attribute of the extracted piece of information to a display attribute for decreasing visibility.

2. The display device of claim 1, wherein
the information displayed on the display is a character sequence,
the attribute setting unit sets a display attribute that defines a character form,
the extraction unit extracts a specified character and a related character, the related character being a character representing information related to the specified character, and
the display control unit causes the extraction unit to extract a predetermined character and a related character related to the predetermined character from a character sequence to be displayed on the display, and causes the attribute setting unit to change a display attribute of at least one of the extracted predetermined character and the extracted related character.

3. The display device of claim 2 further comprising:
a personal information storage unit storing personal information, wherein
the extraction unit extracts, as the related character related to the predetermined character, a character that represents information included in the personal information.

4. The display device of claim 2 further comprising:
a proper noun storage unit storing proper nouns corresponding to the predetermined character, wherein
the extraction unit searches for, as the related character related to the predetermined character, a proper noun that corresponds to the predetermined character.

5. The display device of claim 2, wherein
the display attribute includes a color attribute which defines a color of characters to be displayed on the display, and
the display control unit causes the attribute setting unit to change a color attribute of the extracted related character to a color attribute of a color which is close to a color of a background on which the related character is displayed.

6. A display method for use in a display device provided with a display, the display method comprising the steps of:
displaying information on the display;
setting a display attribute of information to be displayed on the display; and
extracting a piece of information, wherein
the displaying step causes the extracting step to extract a predetermined piece of information from the information to be displayed on the display, and causes the attribute setting step to change a display attribute of the extracted piece of information to a display attribute for decreasing visibility.
